(19) United States
(12) Patent Application Publication
(10) Pub. No.: US 2002/0101731 A1
(43) Pub. Date: Aug. 1, 2002

(54) DETACHABLE LIGHTING FIXTURE AND MIRROR ARRANGEMENT

(76) Inventor: David Lee, Taipei (TW)

Correspondence Address: DAVID LEE, 5th Fl., NO. 755, MINTZU E. ROAD, TAIPEI, TW

(21) Appl. No.: 09/771,456

(22) Filed: Jan. 29, 2001

(51) Int. Cl. F21V 33/00

(52) U.S. Cl. 362/135; 362/374

(57) ABSTRACT

A detachable lighting fixture and mirror arrangement includes a lamp holder shell holding a lamp, and a mirror holding shell holding a mirror, the mirror holder shell having a plurality of axially backwardly extended cylindrical mounting sockets, the lamp holder shell having a plurality of cylindrical mounting rods respectively plugged into the cylindrical mounting sockets of the mirror holder shell, the cylindrical mounting rods each having an annular peripheral groove and a rubber ring mounted in the peripheral groove and respectively pressed against the inside wall of each mounting socket of the mirror holder shell.

### BACKGROUND OF THE INVENTION

The present invention relates to a lighting fixture and mirror arrangement, and more particularly to a detachable lighting fixture and mirror arrangement in which the mirror holder shell is detachably fastened to the lamp holder shell by a plug joint. When the lamp fails to function well, the mirror holder shell can easily be opened from the lamp holder shell for replacement of the lamp.

There are known mirrors with back light means. These mirrors commonly comprises a mirror holder shell holding a mirror, and a lamp holder shell fastened to the back side of the mirror holder shell and holding a lamp on the inside in front of the mirror. When turning on the lamp, heat from the lamp eliminates fog from the mirror. Conventionally, the lamp holder shell is fixedly fastened to the mirror holder shell by screws. In case the lamp fails to function well, the user must use a screwdriver to remove the screws from the mirror holder shell and the lamp holder shell, so that the mirror holder shell can be opened from the lamp holder shell for a replacement of the lamp. Further, the presence of the screws destroys the sense of beauty of the outer appearance of the mirror holder shell. In case the screws are covered with rust, removing the screws from the mirror holder shell and the lamp holder shell may damage the structure of the mirror holder shell and the lamp holder shell.

### SUMMARY OF THE INVENTION

The present invention has been accomplished to provide a detachable lighting fixture and mirror arrangement, which eliminates the aforesaid drawbacks. According to one aspect of the present invention, the lamp holder shell comprises a plurality of cylindrical mounting rods respectively plugged into respective cylindrical mounting sockets at the back side of the mirror holder shell. By pulling the mirror holder shell forwards from the lamp holder shell, the mounting sockets are respectively disconnected from the lamp holder shell. According to another aspect of the present invention, rubber rings are respectively mounted on an annular peripheral groove on each mounting rod of the lamp holder shell, and respectively pressed against the inside wall of each mounting socket of the mirror holder shell after insertion of the respective mounting rods into the respective mounting sockets, keeping the lamp holder shell and the mirror holder shell positively secured together. According to still another aspect of the present invention, the mounting sockets and the mounting rods are kept from sight after connection of the mirror holder shell to the lamp holder shell.

### BRIEF DESCRIPTION OF THE DRAWINGS

FIG. 1 is an exploded view of the present invention.

FIG. 2 is a sectional assembly view of the present invention.

### DETAILED DESCRIPTION OF THE PREFERRED EMBODIMENT

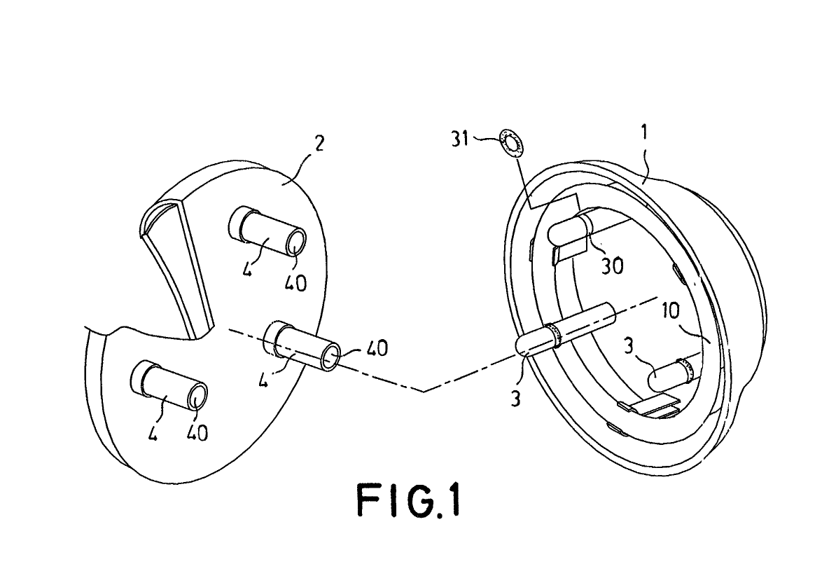

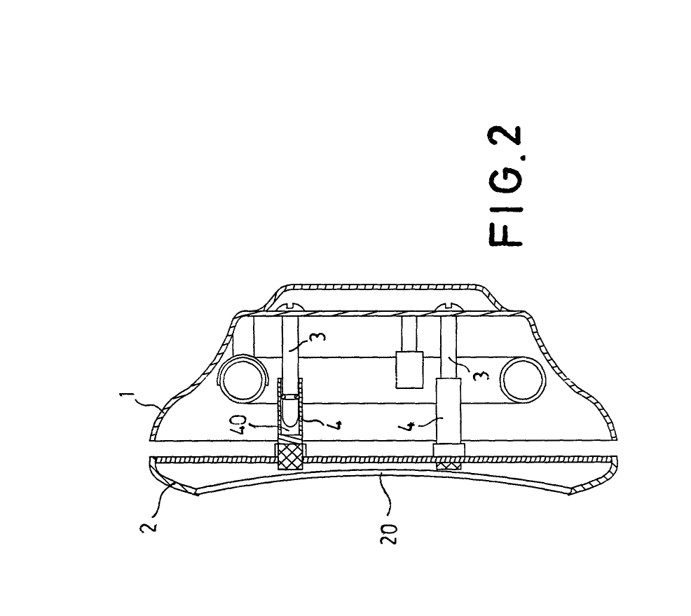

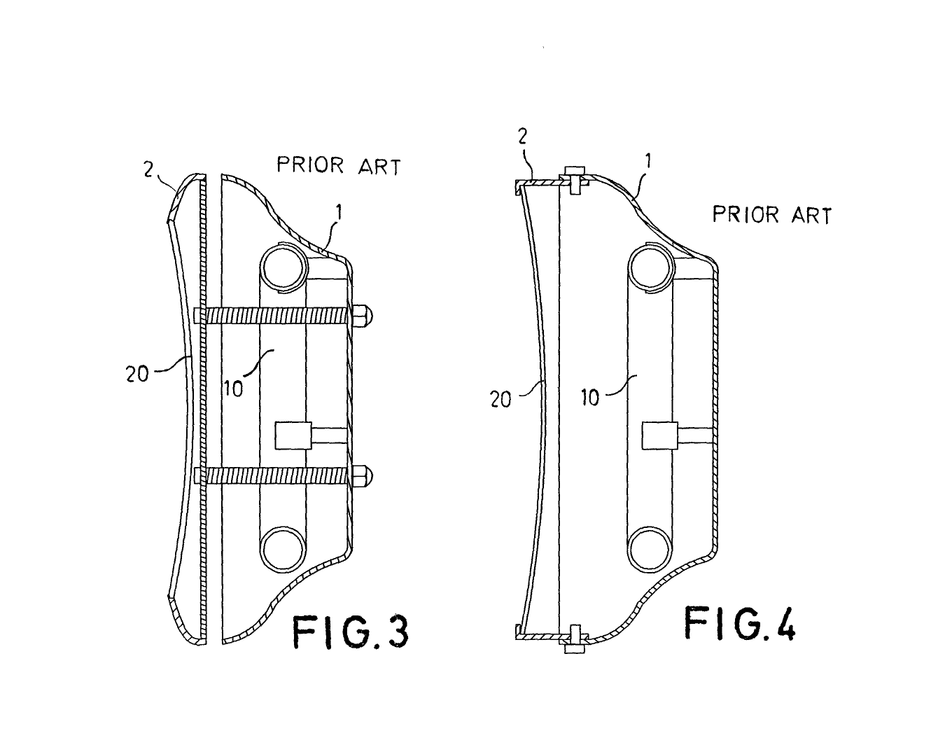

Referring to FIGS. 1 and 2, a detachable lighting fixture and mirror arrangement in accordance with the present invention is shown comprising a lamp holder shell 1 holding a lamp tube 10, and a mirror holding shell 2 holding a mirror 20. The lamp holder shell comprises a plurality of mounting rods 3 suspended on the inside. The mounting rods 3 each have an annular groove 30 around the periphery, and a rubber ring 31 mounted in the annular groove 30. The mirror holder shell 2 comprises a plurality of cylindrical mounting sockets 4 axially backwardly extended from the back sidewall thereof corresponding to the mounting rods 3 of the lamp holder shell 1. The cylindrical mounting sockets 4 each define a coupling hole 40 of diameter approximately equal to the diameter of the mounting rods 3. The rubber rings 31 each have an inner diameter smaller than the diameter of the annular groove 30, and an outer diameter slightly greater than the diameter of the coupling hole 40. By plugging the mounting rods 3 of the lamp holder shell 1 into the coupling hole 40 of each cylindrical mounting socket 4 of the mirror holder shell 2, the rubber rings 31 are respectively squeezed against the inside wall of each cylindrical mounting socket 4 of the mirror holder shell 2, and therefore the lamp holder shell 1 and the mirror holder shell 2 are firmly secured together. In case the lamp tube 10 fails to function well, the mirror holder shell 2 is pulled outwards from the lamp holder shell 1 to disconnect the cylindrical mounting sockets 4 from the mounting rods 3, and therefore the mirror holder shell 2 is separated from the lamp holder shell 1, enabling the lamp tube 10 to be removed from the lamp holder shell 1 for a replacement.

While only one embodiment of the present invention has been shown and described, it will be understood that various modifications and changes could be made thereunto without departing from the spirit and scope of the invention disclosed.

What the invention claimed is:

1. A detachable lighting fixture and mirror arrangement comprising a lamp holder shell holding a lamp, and a mirror holding shell holding a mirror and detachably fastened to said lamp holder shell in front of said lamp holder shell, wherein said mirror holder shell comprises a plurality of cylindrical mounting sockets axially backwardly extended from a back sidewall thereof; said lamp holder shell comprises a plurality of cylindrical mounting rods suspended on the inside and respectively plugged into the cylindrical mounting sockets of said mirror holder shell, said cylindrical mounting rods each comprising an annular groove the periphery thereof and a rubber ring mounted in said annular groove and pressed against an inside wall of the respective cylindrical mounting socket of said mirror holder shell.
